(19) United States
(12) Patent Application Publication
(10) Pub. No.: US 2003/0063426 A1
(43) Pub. Date: Apr. 3, 2003

(54) Microsphere optical device

(75) Inventors: Anatoly Yu Smirnov, Vancouver (CA); Sergey Rashkeev, Nashville, TN (US); Alexandre M. Zagoskin, Vancouver (CA); Jeremy P. Hilton, Vancouver (CA)

Correspondence Address: Pennie & Edmonds, LLP, 3300 Hillview Avenue, Palo Alto, CA, 94304, US

(73) Assignee: D-Wave Systems, Inc.

(21) Appl. No.: 10/232,137

(22) Filed: Aug. 29, 2002

Related U.S. Application Data
(60) Provisional application No. 60/316,133, filed on Aug. 29, 2001.

(51) Int. Cl. H01H 47/00

(52) U.S. Cl. 361/159

(57) ABSTRACT

An optical device having an optical microsphere. Resonant electromagnetic radiation is trapped in the microsphere and manipulated with externally applied electric and magnetic fields to control polarization components of the excited energy within the microsphere. The optical microsphere can be used as a signal inverter. In the single photon regime, the optical microsphere can be used as a mechanism for entangling qubit states coded by the polarization states of whispering gallery modes excited in the microsphere. Furthermore, the device can be used as a switch for the absorption or reflection of photons in response to control photons.

### CROSS REFERENCE TO RELATED APPLICATIONS

This application claims priority from U.S. Provisional Patent Application No. 60/316,133, entitled “Microsphere optical device,” filed on Aug. 29, 2001. U.S. Provisional Patent Application No. 60/316,133 is incorporated herein in its entirety by this reference.

### FIELD OF THE INVENTION

The invention relates to the field of optics, and to the use of optical resonators. Further, the invention relates to an optical device utilized in quantum information processing and communication.

### BACKGROUND OF THE INVENTION

Microsphere optical devices supporting optical whispering-gallery (WG) modes have attracted considerable attention in various fields of research and technology. The combination of a very high Q factor and submillimeter dimensions (typical diameters ranging from a few tens of micrometers to several hundred micrometers) make microsphere optical devices attractive new components for a number of applications, including basic physics research, molecular spectroscopy, narrow-linewidth lasers, optoelectronic oscillators, and sensors. See, for example, Braginsky et al., 1989, Phys. Lett. A 137, 397; Change and Campillo, eds., Optical Processes in Microcavities, World Scientific, Singapore, 1996; Mabuchi and Kimble, 1994, Opt. Lett 19, 749; Vassiliev et al., 1998, Opt. Commun. 158, 305; and Ilchenko et al., 1999, Proc. SPIE 3611, 190, which are hereby incorporated by reference.

Methods of coupling light in and out of whispering-gallery modes in microsphere optical devices, including single-mode fiber couplers and integrated waveguides are being developed. See, for example, Ilchenko, et al. 1999, Opt. Lett. 24, 723; Little et al., 2000, Opt. Lett. 25, 73, which are hereby incorporated by reference in their entirety.

Whispering-gallery modes are essentially closed circular waves trapped by total internal reflection inside an axially symmetric dielectric body. Whispering gallery modes are universal linear excitations of circular and annular resonators. They were first observed in the form of a sound wave traveling along the outer wall of a walkway in the circular dome of St. Paul's Cathedral in London, and were investigated by Lord Rayleigh, 1914, Phil. Mag., 27:100 as well as Jearl Walker, 1978, Scientific American 239(4):147. In a two meter wide walkway, which forms a circular gallery having a diameter of 38 meters, 40 meters above the ground of St Paul's Cathedral, the whispering of a person can be transmitted along the wall to another person listening to the sound on the opposite side of the dome. The investigations by Rayleigh led to the conclusion that the whisper of a person excites acoustic eigenmodes of the circular dome that can be described using high order Bessel functions. This acoustic phenomenon lends its name, whispering gallery mode, to a number of similar, mostly electromagnetic excitations in circular resonators. Whispering gallery modes are of interest in microresonators used for small lasers. See, for example, McCall et al., 1991, Appl. Phys. Lett., 60:289.

The high Q factor of microsphere optical devices results from low optical loss in the material (typically, fiber-grade fused silica), a fire-polished surface with subnanometer-scale inhomogeneities, high-index contrast for steep reduction of radiative and scattering losses with increasing radius, and two-dimensional curvature providing for grazing reflection of all wave-vector components.

The quality factor Q describes the quality of oscillators in which damping decays photons in the oscillator. The quality factor Q corresponds to the number of oscillations during a lifetime of a photon in a microsphere. In some cases, Q can be mathematically described as:

Q≡ωₒ/(Δω)≈ωₒτ

where ωₒ is the resonance frequency, Δω is the full width half maximum of the resonance curve, and τ is photon life time. The photon lifetime is defined as the time period that it takes to accrue an e⁻¹ chance that the photon is gone. This mathematical definition is valid for Q>30. Thus, in microspheres with a high quality factor Q, photons last for a long time without decaying.

Grazing incidence is important for minimizing surface scattering that would otherwise limit Q to far less than the value imposed by attenuation in the material. For example, in integrated optical microring and microdisk cavities based on planar waveguide technology (the light in planar devices is effectively bouncing from flat surfaces at a finite angle), the typical Q factor is only 10⁴ to 10⁵. Microspheres typically have a quality factor that is much higher than 10⁴ to 10⁵. For example, some microspheres have quality factors on the order of 10⁸ or even higher. The substantially higher Q in microsphere optical devices relative to microdisks and microrings comes at the price of a relatively dense spectrum of modes for photons within the microsphere. In ideal microspheres, the spectrum for photons in the microsphere consists of TEₗₘᵢ or TMₗₘᵢ modes separated by a larger free spectral range (FSR) defined by the circumference of the sphere and related to consecutive values of index l. In silica spheres of diameter 150 to 400 microns the larger free spectral range should be in the range of 437 to 165 GHz or, on the wavelength scale, 3.5 to 1.3 nm near the center wavelength of 1550 nm. Each TEₗₘᵢ (or TMₗₘᵢ) mode is (2l+1)-fold degenerate with respect to the index m, where the index m refers to a mode of photon travel in the angular direction (e.g., there are 2l+1 modes of the same energy). As used here, the index m refers to modes of photon travel in the angular direction, the index l refers to modes of photon travel in the azimuthal direction, and the index q refers to modes of photon travel in the radial direction of the microsphere. Residual nonsphericity removes the degeneracy in the mode of photon travel in the angular direction. Thus, the 2l+1 states will adopt different energy levels when a microsphere is shaped with residual nonsphericity. This loss in degeneracy leads to a series of observable TEₗₘᵢ or TMₗₘᵢ modes separated by an observable free spectral range (e.g., energy or wavelengths) for a given sphere dimension, center wavelength, and eccentricity ε² See, for example, Ilchenko et al., 2001, Optics Letters 26, 256, which is hereby incorporated by reference.

The fabrication of an exemplary microsphere optical device is shown with reference to FIGS. 4A-4C. A cylindrical cavity preform of silica is formed with vertical walls as shown in FIG. 4A. In this example, the walls have a diameter of 100 to 200 microns, a thickness of 20 to 40 microns, and are on a relatively flat substrate (not shown). The vertical surface of the vertical walls is next re-shaped to provide removal of the mode field from the flat boundaries as shown in FIG. 4B. This is done by removing the edge portions 400 that form a complex shape shown in FIG. 4B. After that, further thermal and mechanical treatment is used to approach ellipsoidal geometry. The edges, e.g. 410, are rounded and smoothed to minimize surface roughness and reduce radiation loss. By rounding these surfaces, curvature confinement and fire polish grade surface can be obtained, obtaining a Q approaching 10⁸. The cylindrical preform described in FIG. 4A can be produced by wet/dry etch as well as ion milling techniques using appropriate crystal orientation. Other techniques, such as ultraviolet treatment and infrared treatment, can also be used. See, for example, U.S. Pat. No. 6,389,197 to Iltchenko et al., which is hereby incorporated by reference.

Microcavities in photonic crystals are used as microspherical resonators. See, e.g., U.S. Pat. No. 6,058,127 to Joannopoulos et al. Research in this area is directed in part towards the challenge of coupling energy into the photonic crystals.

Electromagnetic energy can be excited and stored for a relatively long period of time in microspherical resonators. As a result of the inherent high quality factor in some microsphere optical devices, localization of electromagnetic energy can be prolonged, thus providing a medium in which to manipulate this energy.

What are needed in the art are devices that can provide high-speed and efficient optical switching and manipulation in optical communication and information processing systems. Further, what is needed in the art are devices that can support quantum communication, which has the potential of providing highly secure channels of communication in which any intercepted information is destroyed.

### SUMMARY OF THE INVENTION

The present invention provides devices that can be used for high-speed and efficient optical switching and manipulation in optical communication and information processing systems. Further, the present invention provides devices that can be used to support quantum communication. The present invention provides a microsphere optical device that has a microsphere having residual nonsphericity, at least one coupling mechanism, and a mechanism for application of an alternating magnetic field in an equatorial plane of the microsphere (FIG. 1A). A coupling mechanism is any device for coupling electromagnetic radiation (e.g., photons) into and out of the microsphere. Examples of coupling mechanisms in accordance with the present invention include coupling fibers and coupling optical prisms. In some embodiments of the present invention, the microsphere has a circular shape in the equatorial plane. In some embodiments, the microsphere has an oblong shape in planes other than the equatorial plane in order to adjust the resonant characteristics of the microsphere. The present invention provides a method for controlling the energy mode of signal photons within the microsphere optical device using an alternating magnetic field that is applied in the equatorial plane of the microsphere. This control of the energy mode is exploited in various applications, including a signal inverter and in the manipulation of a flying qubit.

There are several mechanisms for generating alternating magnetic fields in the equatorial plane of the microsphere in accordance with the present invention. One mechanism includes using a generator that applies an alternating electric field perpendicular to the equatorial plane of the microsphere. Another method provides an alternating current to a current-carrying stem placed through the center of the microsphere in an axis perpendicular to the equatorial plane of the microsphere. Applying an alternating current through this stem establishes a magnetic field in the equatorial plane of the microsphere.

Some embodiments of the microsphere optical device of the present invention couple electromagnetic energy into the microsphere that has transverse magnetic (TM) or transverse electric (TE) polarization modes (resonances). The TM and TE modes correspond to whispering gallery modes of the microsphere having the same azimuthal quantum number m=±1ₛ but different polarizations. Here, 1ₛ is an angular momentum of the whispering gallery mode. Furthermore, the frequencies of the TM and TE modes, f_{TM} and f_{TE}, are each much greater than the frequency f₁ of an alternating magnetic field that is applied in the equatorial plane of the microsphere optical device. However, the value of the differential f_{TM}−f_{TE} is about the same as f₁.

The electromagnetic energy that is coupled into the microsphere in some embodiments of the present invention includes signal photons. Data signals can be stored in the polarization modes of the signal photons. In addition to signal photons, the electromagnetic energy that is coupled into the microsphere in some embodiments of the present invention includes control photons. Similar to the case of the alternating magnetic field applied in the equatorial plane of the microsphere optical device, the control photons can be used to manipulate the polarization mode of the signal photons in accordance with some embodiments of the present invention.

In the absence of control photons, and with many signal photons, an optical device according to the present invention can be a signal inverter. In one embodiment in accordance with the present invention, the information in the signal is stored in the polarization modes associated with the TE and TM modes of signal photons within the microsphere. A signal inverting optical device system includes the microsphere, at least one coupling mechanism, and a mechanism for generating an alternating magnetic field in the equatorial plane of the microsphere. If the signal photons are in a TM polarization mode, then the frequency of this mode, f_{TM}′, will be higher than the unperturbed frequency f_{TN} due to the Kerr shift: f_{TM}′>f_{TM}. Applying a resonant magnetic field with frequency f₁′=f_{TM}′−f_{TE} in the equatorial plane will induce a transition of signal photons from the TM-polarized state to the TE-polarization state.

The excited electromagnetic energy in the microsphere can have an intensity corresponding to a single photon. In this regime, the device acts as a quantum information and communication device. Some embodiments of the invention operate with the single photon wave packet. A single photon with polarization with a TM or TE polarization mode can serve as a “flying qubit” in accordance with some embodiments of the invention. The flying qubit retains all information about its state after it has left the microsphere optical device, thus providing an ability to carry a qubit state (quantum state) through a quantum network. The microsphere optical device provides a mechanism for controlling the state of the single photon with the polarization. This allows the photon to serve as a flying qubit.

Further, optical devices according to some embodiments of the present invention act as a quantum gate for controlling oscillation between the basis states of a flying qubit. One such quantum gate is the quantum computing σₓ operation. Optical devices according to some embodiments of the present invention operate as a switch in which signal photons are reflected or absorbed depending upon the respective presence or absence of control photons.

These and other embodiments of the invention are further described below with respect to the following figures.

### SHORT DESCRIPTION OF THE FIGURES

FIG. 1A shows a cross-sectional view through an equatorial plane of an optical device according to one embodiment of the present invention.

FIG. 1B shows a coordinate system used to describe microspheres.

FIG. 2 illustrates a cross-sectional view through an equatorial plane of an optical device according to one embodiment of the present invention.

FIG. 3 illustrates the relationship of the frequencies and polarization modes in an optical device according to one embodiment of the present invention.

FIG. 4 illustrates steps for the formation of a microsphere optical device in accordance with the prior art.

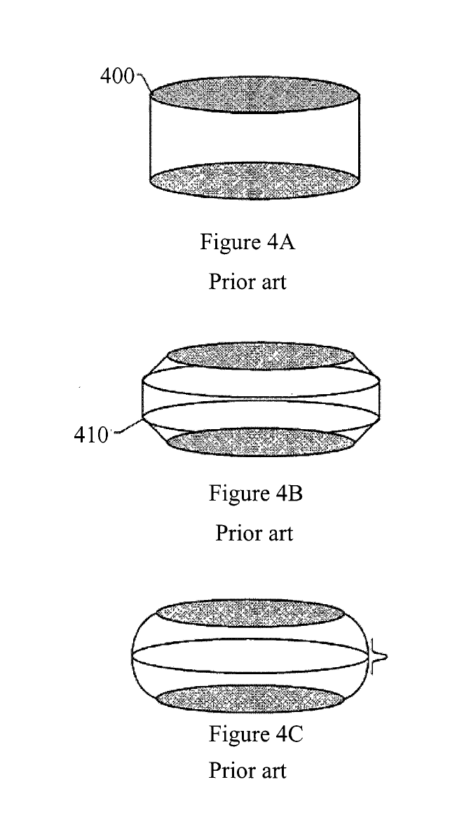

Like reference numerals refer to the corresponding parts throughout the several views of the drawings.

### DETAILED DESCRIPTION

### Optical Devices of the Invention

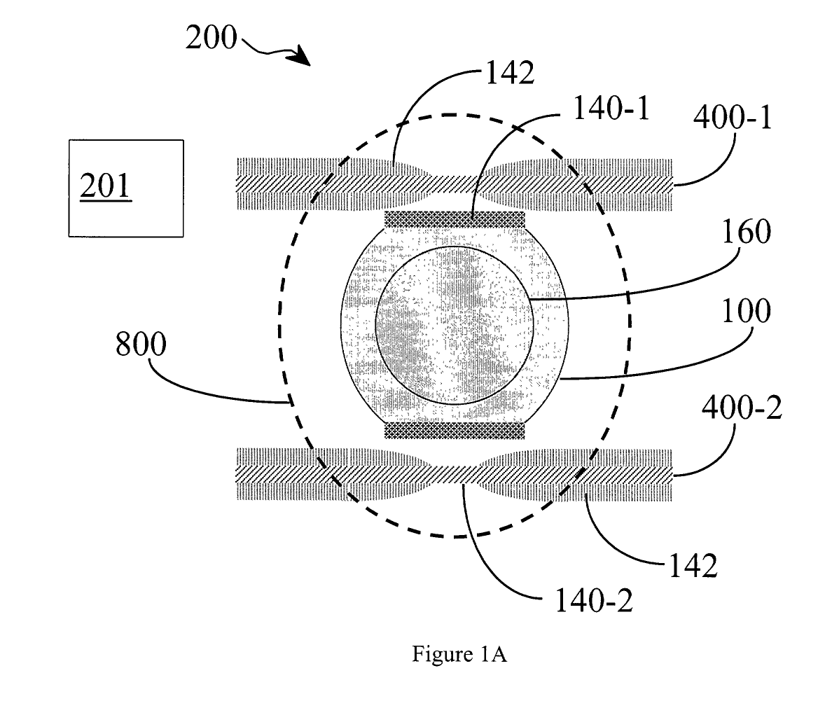

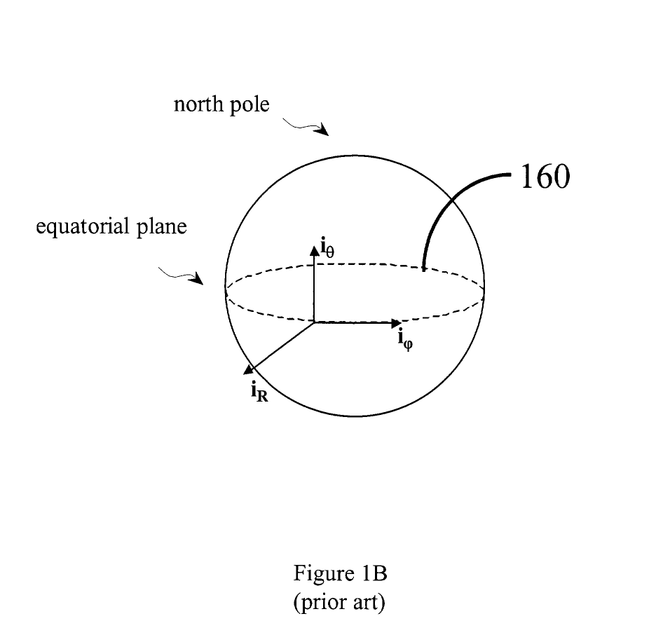

FIG. 1A shows a cross-sectional view through an equatorial plane 160 of a microsphere 100 in an embodiment of an optical device 200 according to the present invention. Equatorial plane 160 is referred to as the dominant plane of microsphere 100. Microsphere 100 is one example of an optical resonant device. Optical device 200 shown in FIG. 1A includes a microsphere 100, coupling devices 400-1 and 400-2, and a source of an electromagnetic field 800. In some embodiments of the present invention, microsphere 100 has a shape that removes degeneracy between TEₗₘᵢ (or TMₗₘᵢ) resonance modes of photons with microsphere 100. In some embodiments of the present invention, degeneracy between resonance modes is removed by making the equatorial plane 160 (dominant plane) of the microsphere circular while contracting or elongating the remainder of the microsphere. In still other embodiments of the present invention, the microsphere can be a microtorus.

With respect to microspheres, the following notation is used: radial direction is out of the sphere, i.e., normal vector i_{R} (FIG. 1B), angular direction i_{θ} (FIG. 1B) is in the plane 160 that is tangential to the sphere but points to a pole, and azimuthal direction i_{φ} (FIG. 1B) is in the plane 160 that is tangential to the sphere but points along the equator. These unit vectors define a local coordinate system that in convenient when describing the features of a microsphere and the modes within it. Note, as a local coordinate system the unit vectors i_{R}, i_{θ}, and i_{φ} are not merely rotations of the unit vectors of the inertial or lab frame (i.e., i, j, k). For instance the direction of i_{θ} on the near side of the equatorial plane, as depicted in FIG. 1B, is 180° reversed from the direction of i_{θ} on the far side of the equatorial plane. The unit vectors i_{R}, i_{θ}, and i_{φ} obey standard i, j, k commutator relations like vectors in three space as follows:

| Classical | Corresponding | Alternative |
|---|---|---|
| commutator | commutator | commutator |
| relations | relations | relations |
| i × j = k | i_{R} × i_{φ} = i_{θ} | i_{R} × i_{θ} = −i_{φ} |
| j × k = I | i_{φ} × i_{θ} = i_{R} | i_{θ} × i_{φ} = −i_{R} |
| k × i = j | i_{θ} × i_{R} = i_{φ} | i_{φ} × i_{R} = −i_{θ} |

Optical devices 200 have at least one coupling mechanism 400. In FIG. 1A, two coupling mechanisms, 400-1 and 400-2 are illustrated. In some cases, signal and control photons can be introduced into microsphere 100 through a single coupling mechanism. In the embodiment shown in FIG. 1A, signal and control photons are introduced into microsphere 100 through coupling mechanisms 400-1 and 400-2, respectively. In some embodiments of the present invention, the control photons can be excited through the same coupling mechanism as the signal photons. Embodiments of the present invention include arranging microspheres 100 in a linear array all attached to the same coupling mechanism or coupling mechanisms. Embodiments of the invention include arranging the microspheres in a two dimensional array. In such embodiments, there can be two sets of coupling mechanisms with orthogonal directions.

In the optical device 200 illustrated in FIG. 1A, coupling mechanism 400-1 is used to introduce signal photons into microsphere 100 and coupling mechanism 400-2 is used to introduce control photons into microsphere 100. Various embodiments of optical device 200 have any number of coupling mechanisms 400. For example, in some embodiments, optical device 100 has three coupling mechanisms 400, four coupling mechanisms 400, or more. In general, coupling mechanisms 400 are used to introduce photons into microsphere 100.

One form of electromagnetic energy signal is photons (e.g. signal photons) and one form of an optical resonant device is microsphere 100. The introduction of signal photons (e.g., an electromagnetic energy signal) into microsphere 100 by one or more coupling mechanisms 400 is referred to herein as exciting an electromagnetic energy signal in an optical resonant device. The introduction of control photons (e.g., an electromagnetic energy signal) into microsphere 100 by one or more coupling mechanisms 400 is referred to herein as exciting an electromagnetic energy control signal.

In some embodiments, an alternating magnetic field H₈₀₀ is introduced into equatorial plane 160 of microsphere 100 (FIG. 1A). The magnetic field H₈₀₀ is parallel to the direction vector i_{φ}. It is therefore called an azimuthal field or a tangential field with respect to the surface of microsphere 100. The alternative magnetic field makes a tangent with the surface, i.e., H₈₀₀=|H₈₀₀|i_{φ}. In some embodiments, the electromagnetic energy signal (e.g. signal photons) has at least one polarization state in the optical resonant device and information can be stored in the at least one polarization state. For example, in some embodiments of the present invention, the signal photon has a TE or TM polarization state and information is stored in this state in the same bit form found in classical computers, where one voltage state represents a “1” and another voltage state represents a “0”. By analogy, one polarization state of the signal photon in the optical resonant device may represent a “1” and another polarization state of the signal photon in the optical resonant device may represent a “0”. In this way, information can be stored in the polarization state of the elecromagnetic energy in an optical resonant device.

In some embodiments of the present invention, a field E₈₀₀ is applied to the microsphere resulting in an alternating magnetic field H₈₀₀ in equatorial plane 160. In some embodiments E₈₀₀ is an alternating electric field. In some embodiments E₈₀₀ is an alternating electric field that is applied to microsphere 100 in a direction normal to equatorial plane 160 (FIG. 1A). For example, a conductive channel is introduced in the microsphere running at a normal to the equatorial plane and traversing the center of the microsphere. In some embodiments of microsphere 100, the induction of a stem (not shown) can be done during the manufacturing of microsphere 100. For example, in the case of a microtorus, a silver thread can be induced in the center of the fiber optic wire from which the microtorus is fashioned. In some embodiments, H₈₀₀ is generated by an oscillating current through a stem passing through microsphere 100 (not shown) perpendicular to equatorial plane 160. In some embodiments, H₈₀₀ is pulsed (i.e., turned on and off) and the duration of the pulses corresponds to a single oscillation between the TMₗₘᵢ and TEₗₘᵢ mode of signal photon(s) that are in microsphere 100.

In FIG. 1A, coupling mechanisms 400-1 and 400-2 are optical fibers. In some embodiments, material 140 is placed between coupling mechanism 400 and microsphere 100 to facilitate coupling. In some embodiments material 140 is Canada balsam (Edmond Scientific, Tonawanda, N.Y.). In some embodiments, material 140 is an antireflective coating, such as magnesium fluoride, zirconium dioxide, or titanium oxide. In some embodiments of the present invention, the index of refraction of material 140, n₁₄₀, is about equal to the square root of n₄₀₀ times n₁₀₀, where n₄₀₀ is the index of refraction of coupling mechanism 400 and n₁₀₀ is the index of refraction of the microsphere. In some embodiments, optional material 140 has a thickness that does not exceed one quarter of the wavelength of the photon exiting coupling mechanism 400-1 and 400-2 and entering microsphere 100. In some embodiments, n₄₀₀ is about 1.62 (minimized attenuation). In some embodiments, microsphere 100 is made of fused silica that has an index of refraction n₁₀₀ of 1.45. In some embodiments of the invention, material 140 is not present. In some embodiments in which coupling mechanism 400 is an optical fiber, outer cladding 142 of the optical fiber is removed in the vicinity of microsphere 100 to facilitate coupling of photons from mechanism 400 into microsphere 100. Photons in the infrared spectrum (e.g., λ=1.55 microns) are used as signal photons for many embodiments of microsphere 100.

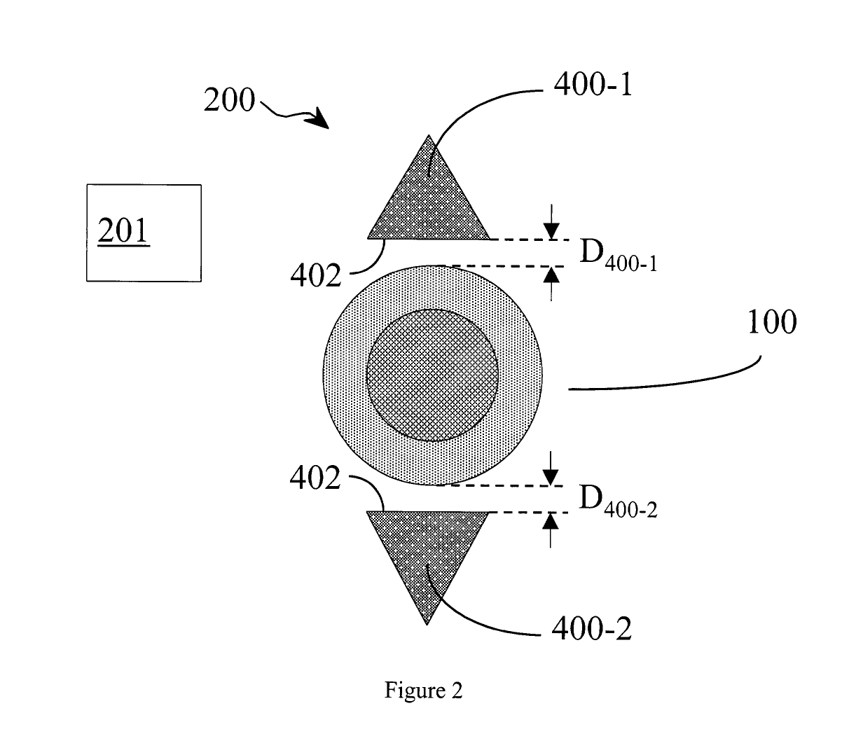

FIG. 2 shows an embodiment of optical device 200 where coupling mechanisms 400-1 and 400-2 are prisms rather than optical fibers. Photons can be coupled with microsphere 100 through prisms 400. In other words, prisms 400 can be used to introduce photons into microsphere 100. For example, in one embodiment, a laser light having a wavelength λ_{C} corresponding to the TM or TE polarization modes of a whispering gallery mode of a microsphere is directed toward the prism (FIG. 2). Because the laser light is directed toward the prism, photons are introduced into the prism. Once the photons are introduced into the prism, they reflect off the prism walls. When a photon attempts to reflect off of prism wall 402, it is introduced into microsphere 400 by a mechanism known as frustrated total internal reflection. See Hecht, Optics, Third edition, Addison-Wesley, New York, 1998, p. 125, which is hereby incorporated by reference in its entirety. In some embodiments, distances D₄₀₀₋₁ and D₄₀₀₋₂, respectively separating prisms 400-1 and 400-2 from microsphere 100 (FIG. 2), are about equal to, or less than, half the wavelength of the incoming photon i.e. λ_{C}/2. For example, if D₄₀₀₋₁ is larger than λ_{C}/2 the electromagnetic energy will not be excited in the microsphere.

In some embodiments of the present invention, coupling devices 400 use lasers to introduce photons into microsphere 400. In the case where coupling devices 400 are prisms, a laser is directed on the prism surface. In the case where coupling devices 400 are optical fibers, the laser is directed into the optical fiber. The wavelength of the laser used in the present invention will depend on the physical characteristics of microsphere 100, including the size of microsphere 100 and the material used to make the microsphere. In some embodiments, a laser is chosen from the wavelength range of 1 to 2 microns and the microsphere 100 is designed so that it will work at the chosen wavelength. In some embodiments of the present invention, the laser used for coupling devices 400 is a Nd laser (λ=1.06 microns) with a yttrium aluminum garnet (YAG), glass, or YLF (LiYF₄) solid host. In some embodiments of the present invention, the laser used for coupling devices 400 is a Helium-Neon laser (λ=1.15 microns), a Nd-YLF laser (λ=1.313 microns), an iodine laser (λ=1.315 microns), a Nd-YAG laser (λ=1.32 microns), a InGaAsP diode laser (λ=1.2 to 1.6 microns), a color center laser (λ=1.4-1.6 microns), a He—Ne laser (λ=1.523 microns), or an erbium-fiber amplifier laser (λ=1.54 microns).

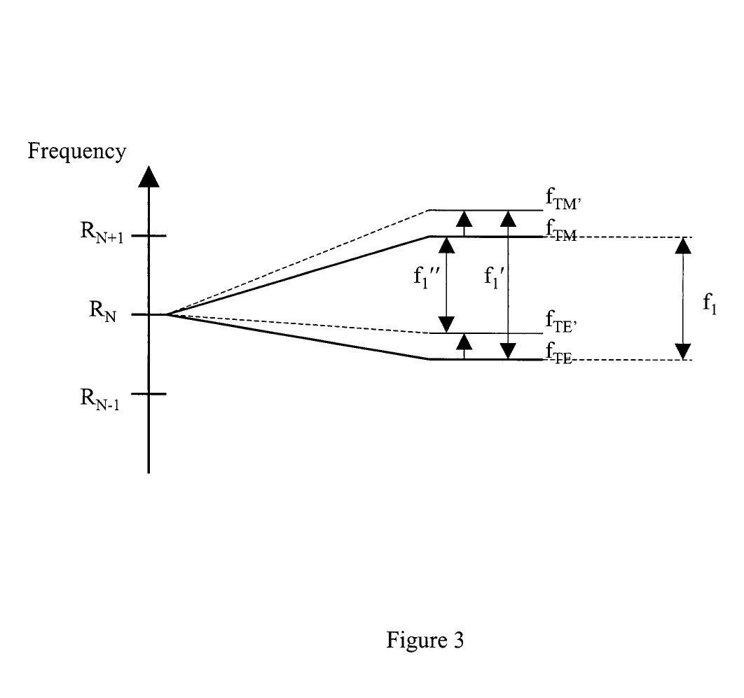

Through the use of coupling mechanisms 400, photons can be introduced into microspheres 100 as well as removed from microspheres 100. Thus, the introduction of photons into microsphere 100 is a reversible event. The photons are introduced into microspheres 100 in a whispering gallery mode. The whispering gallery modes of the photons introduced into microspheres 100 by coupling mechanisms can be classified into two modes, the transverse magnetic modes (TM modes) and transverse magnetic modes (TE modes). FIG. 3 illustrates the frequencies of the transverse magnetic mode (TM mode) and transverse magnetic mode (TE mode) of the control and signal photons resonating in microsphere 100 for a given quantum number (l, m, i). Just as coupling mechanisms 400 add photons to microsphere 100, the coupling mechanism 400 remove photons from microsphere 100 at a given rate through the phenomenon of frustrated total internal reflection. Thus, the number of photons (either control or signal photons) in microsphere 100 at any given time is a function of the rate at which coupling mechanisms 400 are adding photons to microsphere 100 and the rate at which coupling mechanism 400 are actually removing photons from microsphere 100.

The TM mode is an energy mode whose magnetic field vector is normal to the direction of propagation. The TE mode is an energy mode whose electric field vector is normal to the direction of propagation. While the TE and TM modes of a hollow wave-guide made of a conductor are easy to visualize because there is a clear direction of propagation, the modes in a microsphere are more difficult to visualize. Using the reference frame defined in FIG. 1B, we can define the TE and TM modes as follows.

The TE mode “transverse electric mode”, i.e., E_{θ}≠0, is a polarization mode for photon(s) in microsphere 100 and can be defined as:

| | | |
|---|---|---|
| E_{R} = 0, | E_{θ} ≠ 0 (large), | E_{φ} = 0 |
| H_{R} ≠ 0, | H_{θ} = 0, | H_{φ} ≠ 0 (small) |

where E_{R} is the electric field in the radial direction, E_{θ} is the electrical field in the angular direction, and E_{φ} is the electrical field in the azimuthal direction. In the case of the TE mode, these electrical field components are respectively denoted E_{R}^{(TE)}, E_{θ}^{(TE)}, E_{φ}^{(TE)}. Therefore, the electric field is in the plane of the surface and perpendicular to equatorial plane 160 with no other components (i.e., parallel to i_{θ}). There is a magnetic field in the radial direction and a small component in the azimuthal direction (i.e., parallel to i_{φ}). In the TE mode, E_{θ}^{(TE)} is the dominant electrical and magnetic component of the mode.

The TM mode “transverse magnetic mode”, i.e., H_{θ}≠0, is a polarization mode for photon(s) in microsphere 100 and can be defined as:

| | | |
|---|---|---|
| E_{R} ≠ 0 (large), | E_{θ} = 0, | E_{φ} ≠ 0 (small) |
| H_{R} = 0, | H_{θ} ≠ 0, | H_{φ} = 0 |

Therefore, the electric field is perpendicular to the surface with a small components in the azimuthal direction. There is a magnetic field in the angular direction.

Two types of photons used in microspheres 100, signal (or target) photons and control photons. Signal photons and control photons need not have the same frequencies. In fact, the energy separation between these two groups of photons is, in general, much bigger than the typical energy difference between the TM and TE modes of photons in microsphere 100 that have the same quantum number (l, m, i) (FIG. 3). Each of the photons can be in the TM or TE polarization state.

In some embodiments of the present invention, the signal and/or control photons in microsphere 100 are contained in a core region of the microsphere by the phenomenon of total internal reflection (TIR). For any given (l, m, i) value, each TM and each TE energy mode of a signal photon has a characteristic frequency. The frequency for the TM energy mode of the signal photon is denoted f_{TM}. The frequency for the TE energy mode of the signal photon is denoted f_{TE}. Furthermore, the process of total internal reflection gives rise to a frequency shift Δf=f_{TM}−f_{TE} (see FIG. 3).

In some embodiments of the present invention, the energy mode of signal photons does not change while stored in microsphere 100. For example, in some embodiments of the present invention, signal photons that are introduced into microsphere 100 in the TM energy mode of a given (l, m, i) value, stay in the TM energy mode for that (l, m, i) value. Further, in some embodiments of the present invention, signal photons that are introduced into microsphere 100 in the TE energy mode of a given (l, m, i) value, stay in the TE energy mode for that given (l, m, i) value.

In some embodiments of present invention, the signal photons in microsphere 100 are shifted between their TM and TE energy modes using the Faraday effect. The Faraday effect describes the relationship between a magnetic field and polarized light. In the case of microspheres, the magnetic field polarizes the signal photons so that they change from their TM to the TE mode, or vice versa. The Faraday effect is further described in Hecht, Optics, Third edition, Addison-Wesley, New York, 1998, p. 362, which is hereby incorporated by reference.

In one example, signal photon(s) have a polarization, E_{θ}^{(TE)} in the correlated TE mode frequency, and a polarization E_{T}^{(TM)} in the correlated TM mode frequency. The provision of tuning or oscillating signal energy to microsphere 100 to switch signal photons between the TE and TM energy modes is accomplished by generating an alternating magnetic field H₈₀₀ in the equatorial plane 160 of microsphere 100 (FIG. 1). Alternating magnetic field H₈₀₀ can be generated by application of an alternating electric field perpendicular to the equatorial plane 160 of microsphere 100. Alternating magnetic fields tangential to the equatorial plane of the microsphere can also be generated by applying an alternating current to a current-carrying stem inserted through the center of microsphere 100 along an axis perpendicular to the equatorial plane.

Generally speaking, the signal photons or a portion of the signal photons in microsphere 100 will be in the same (l, m, i) state (quantum number). In addition, the frequency of the alternating magnetic field H₈₀₀ is set so that it is about the same as the frequency difference between the TE and TM energy modes of the signal photons in the given (l, m, i) state. The frequency difference between the TE and TM modes of the signal photons depends on the embodiment of the invention. For example, factors such as eccentricity of microsphere 100, the material used to make microsphere 100, the diameter of microsphere 100, and the wavelength of the signal photons affect the frequency difference between the TE and TM modes of the signal photons for a given (l, m, i) state. In some embodiments, the energy difference between the TE and TM energy modes of the signal photons in a given (l, m, i) state is between about 100 GHz and about 600 GHz.

In some embodiments of the present invention, the alternating magnetic field is applied using a field generator 201. In some embodiments, field generator 201 is a set of parallel plates above and below microsphere 100. The conducting plates are coplanar to the equatorial plane. Attached to each conducting plate is a lead from a commercially available high frequency generator, such as a PSG Series Signal Generator (Agilent Technologies, Palo Alto, Calif., U.S.A.).

In some embodiments of the present invention, the alternating magnetic field H₈₀₀ is applied for a duration t that induces an oscillation of the signal photon(s) from one polarization state to another (e.g., from the TM state to the TE state of the signal photons, or vice versa).

Additionally, an oscillation between the TE and TM states of the signal photons can occur in the presence of an alternating magnetic field. This phenomenon will occur with a frequency Ωₒ that is directly proportional to the amplitude of alternating H₈₀₀ (Ωₒ=2β|H₈₀₀, where β depends on the Verdet constant of the material). In the case where microsphere 100 is made of fused silica, a typical value for Ωₒ is 10⁸ Hz in the presence of a uniform field having a strength of 1000 Gauss. Therefore, in this case, the transition time for a signal photon to alternate between TM and TE modes is about 10⁻⁸ seconds.

### Switches

Some embodiments of optical device 200 operate as a switch. Such embodiments comprise microsphere 100, field generator 201 and at least one coupling mechanism 400. Optical device 200 operates as an optical switch by applying an alternating magnetic field H₈₀₀ in plane 160 (FIG. 1A), exciting signal energy in the microsphere (signal photons), and control energy with a polarization corresponding to the signal energy in the microsphere but having a different frequency.

Creation of an alternating magnetic field H₈₀₀ with a frequency f₁=Δf=f_{TM}−f_{TE} corresponding to the frequency difference between the TM and TE energy modes of the signal photons in microsphere 100 can induce oscillations between the TM and TE energy modes, regardless of their initial polarization. This effect can be described as a Faraday rotation of the polarization of signal photons. Application of H₈₀₀ at a frequency less than or greater than f₁ will not affect the polarization of signal photons unless control photons are used.

In some embodiments of the invention, the frequency f_{TM} of the TM mode of the signal photons in microsphere 100 is more than the frequency f_{TE} of the TE mode of the signal photons. This is the situation illustrated in FIG. 3. Now consider the case in which an alternating magnetic field H₈₀₀ is applied in plane 160 of microsphere 100 with a frequency f₁′ that does not equal f₁, where f₁=Δf=f_{TN}−f_{TE}. As discussed above, in such instances H₈₀₀ will fail to resonate the polarization state of the signal photons. That is, H₈₀₀ will fail to cause signal photons to shift between the TE and TM states.

Now consider the same case as above with the exception that the frequency f₁′, in fact, represents the frequency difference between the Kerr effect-shifted TM mode of signal photons (f_{TM′}) and the unshifted TE mode of signal photons (f_{TE}) of a microsphere 100 as illustrated in FIG. 3. As discussed above, in such instances, H₈₀₀ will still fail to resonate the polarization state of the signal photons because f₁′, the frequency of H₈₀₀ in this case, is still not equal to f₁. The Kerr effect describes the polarization response of polarized light in an electric field. See, for example, Hecht, Optics, Third edition, Addison-Wesley, New York, 1998, p. 363, which is hereby incorporated by reference.

Next, consider the case in which control photons are added. Control photons in microsphere 100 that are TM polarized at a different (q, l, m) index, and therefore have a different frequency than TM polarized signal photons in microsphere 100, will create a Kerr effect shift of the eigenfrequency of the TM mode of the signal photons within microsphere 100 from the value f_{TM} to the value f_{TM}′, where f_{TM}′ can be greater than f_{TM}. When this happens, the frequency that will cause the signal photons to resonate between a TM (TM′) and a TE state will change from f₁ (where f₁=f_{TM}−f_{TE}) to f₁′ (where f₁′=f_{TM}−f_{TE}). Therefore, the magnetic field H₈₀₀, which has a frequency f₁′, will cause the signal photons to resonate.

The same effect can occur when the frequency of H₈₀₀ is f₁″, where f₁″ is the frequency difference between the natural TM-mode f_{TM} of the signal photon(s) and the Kerr effect-shifted TE mode f_{TE}′ of the signal photons, where f_{TE}′>f_{TE}, thus f₁″=f_{TM}−f_{TE}′, and f₁″<f₁. In this case, control photons at the TE polarization mode of a different (q, l, m) index then the (q, l, m) index of the signal photons will initiate the oscillations of polarization of the signal photons in the presence of a alternating magnetic field H₈₀₀ having a frequency f₁″.

As illustrated in the cases above, the invention advantageously provides the ability to change the polarization state of signal photons in microsphere 100 when control photons have the same polarization state (TM or TE) as the signal photons. Although the control photons are in the same polarization state (TM or TE) as the signal photons, they typically have a frequency that is different from that of the signal photons because they are at a different (q, l, m) index. The control photons interact with the signal photons by the Kerr effect when they have the same polarization (TM or TE) as the signal photons. For example, the presence of control photons in microsphere 100 with a TM polarization will shift the frequencies of signal photons in microsphere 100 that have a TM polarization in the presence of a field H₈₀₀ that is at the appropriate frequency. The same is true for the Kerr interactions between TE-polarized signal photons and TE-polarized control photons.

In some embodiments of the invention, an alternating field H₈₀₀ has a frequency corresponding to the difference between the Kerr effect-shifted frequency of the signal photon, having a definite polarization, and the frequency of the signal photon with opposing polarization. For example, if the signal photon is in the TE mode and its frequency f_{TE}′ is shifted due to control photons also polarized in the TE mode, the frequency difference between the TE and TM energy modes of the signal photon will be changed to f₁″, where f₁″=f_{TM}−f_{TE}′, f₁″<Δf, and Δf=f_{TM}−f_{TE}. If alternating magnetic field H₈₀₀ is at frequency f₁″, then the field will cause oscillations (resonance) of the signal photon polarization. Furthermore, these oscillations will only take place when a pulse of TE-polarized control photons is present in microsphere 100. Furthermore, applying field H₈₀₀ having a frequency equal to the difference between the Kerr-shifted TM mode and unchanged TE mode, f₁′=f_{TM}′−f_{TE}, where f₁′>Δf, will result in a change in the polarization of the signal photons only if a pulse of TM-polarized control photons are present in microsphere 100. Thus, embodiments of the invention provide an optical switch for controlling and manipulating the polarization of the signal photons by manipulating the control photons with alternating field H₈₀₀. In some embodiments of the invention, the number of control photons (which is proportional to the intensity of control electromagnetic field) can be much more than the number of signal photons (which is proportional to the intensity of signal electromagnetic field).

### Signal Inverter

In some embodiments of the present invention optical device 200 is used as a signal inverter. When used as a signal inverter, it is contemplated that the TE and TM polarization modes of signal photons in microsphere 100 actually store information in a bitstate manner. Optical device 200 can be used to invert the polarization modes of the signal photons in microsphere 200 from the TE mode to the TM mode and vice versa. In this novel capacity, optical device 200 acts as a bit state converter (or a NOT gate).

Physical embodiments of optical device 200 utilized as a signal inverter include the components described above. Namely, optical device 200 includes a microsphere 100, at least one coupling mechanism 400, and generator 201. Coupling mechanism 400 is used to introduce signal photons and control photons into microsphere 100. Generator 201 is used to create alternating magnetic field H₈₀₀ (FIG. 1A).

In one embodiment, alternating H₈₀₀ has a frequency that is about the frequency difference f₁′ (FIG. 3), where f₁′ is the difference between the Kerr shifted TM mode (TM′) and the native TE mode of the signal photons in a given (q, l, m) index. Optical device 200 uses a coupling mechanism 400 to pulse control photons into microsphere 100. The control photons are in the TM mode. However, the (q, l, m) index of the control photons is not the same as the (q, l, m) index of the signal photons. Control photons in microsphere 100 that are TM polarized at a different (q, l, m) index, and therefore have a different frequency than TM polarized signal photons in microsphere 100, will create a Kerr effect shift of the eigenfrequency of the TM mode of the signal photons within microsphere 100 from the value f_{TM} to the value f_{TM}′, where f_{TM}′ can be greater than f_{TN} (FIG. 3). When this happens, the frequency that will cause the signal photons to resonate between a TM (TM′) and a TE state will change from f₁ (where f₁=f_{TM}−f_{TE}) to f₁′(where f₁′=f_{TM}−f_{TE}). Therefore, the magnetic field H₈₀₀, which has a frequency f₁′, will cause the signal photons to resonate in the presence of these control photons. Furthermore, optical device 200 pulses the control photons into microsphere 100 for a time period that will cause the polarization state of the signal photons to invert from their original state (TM or TE) to the alternate state (TE or TM).

Typically control photons are added to microsphere 100 using devices 400 (FIG. 2) on a pulsed basis. That is, control photons are added to microsphere 100 for a time period that is less than, for example, the inverse of Ωₒ (e.g., the time it takes all signal photons to invert from one polarization mode to the other polarization mode for a given H₈₀₀. There are two rates of concern. The first rate R₁ is the rate at which photon are introduced into microsphere 100 using devices 400 and the second rate R₂ is the rate at which photons leave microsphere 100 using devices 400. Rate R₂ is constant. That is, photons leave microsphere 100 on a constant basis given the fixed geometry of devices 400 relative to microsphere 100 as illustrated, for example, in FIGS. 1A and 2 by the mechanism of frustrated total internal reflection. Rate R₁ is also constant but pulsed on a time period less than the inverse of Ωₒ. In order to add photons to microsphere 100, therefore, R₁ must be greater than R₂ during the pulse.

In another embodiment, the alternating magnetic field has a frequency corresponding to the frequency difference between the TM mode and the Kerr shifted TE mode of microsphere 100 (i.e., f₁″, FIG. 3). Further, H₈₀₀ has a frequency that is about the frequency difference f₁″ (FIG. 3), where f₁″ is the difference between the Kerr shifted TE mode (TE′) and the native TM mode of the signal photons in a given (q, l, m) index. Optical device 200 uses a coupling mechanism 400 to pulse control photons into microsphere 100. The control photons are in the TE mode. However, the (q, l, m) index of the control photons is not the same as the (q, l, m) index of the signal photons. Control photons in microsphere 100 that are TE polarized at a different (q, l, m) index, and therefore have a different frequency than TE polarized signal photons in microsphere 100, will create a Kerr effect shift of the eigenfrequency of the TE mode of the signal photons within microsphere 100 from the value f_{TE} to the value f_{TE}′, where f_{TE}′ can be greater than f_{TE} (FIG. 3). When this happens, the frequency that will cause the signal photons to resonate between a TE (TE′) and a TM state will change from f₁ (where f₁=f_{TM}−f_{TE}) to f₁″ (where f₁″=f_{TM}−f_{TE}′). Therefore, the magnetic field H₈₀₀, which has a frequency f₁″, will cause the signal photons to resonate in the presence of these control photons. Furthermore, optical device 200 pulses the control photons into microsphere 100 for a time period that will cause the polarization state of the signal photons to invert from their original state (TM or TE) to the alternate state (TE or TM). It will be appreciated by one of ordinary skill in the art that the control photons are typically added to microsphere 100 for a time period that is not greater than inverse of Ωₒ in order to prevent resonance of the signal photons.

In operation, a signal inverter is used to flip each bit in an optical signal in which the bitstates are stored in the TM and TE mode polarizations. In some embodiments, the control photon pulse acts as a clocking mechanism to control the operating speed of optical device 200.

In some embodiments, the polarization state of the signal photons is inverted without the use of control photons. Such embodiments take advantage of the phenomenon that signal photons in the same polarization state can actually induce a Kerr shift in the polarization state of the signal photons. For example, consider the case in which signal photons are in the TM polarization state. Then, H₈₀₀ having the frequency f₁* is applied. Here, f₁*=f_{TM}*−f_{TE}, where f_{TM*} is the eigenfrequency of TM-polarized signal photon that has been shifted by the Kerr effect due to the presence of the signal photons in the TM polarized state. In some instances, f_{TM}* is greater than f_{TM}. Therefore, H₈₀₀ having the frequency f₁* initiates a transition of signal photons into the TE-polarized state. The transition of signal photons from the TM mode to the TE mode will decrease the frequency of the Kerr effect shifted TM mode and increase the frequency of the TE mode (again through the Kerr effect). As a result, the effective frequency (Kerr induced frequency) of the TM polarization state for the signal photons will decrease. Further, the effective frequency (Kerr induced frequency) of the TM polarization state for the signal photons will increase. Thus, similar to the state illustrated in FIG. 3, the frequency difference between the TE and TM polarization modes of the signal photons in microsphere 100 will decrease as signal photons invert from the TM to the TE state. Consequently, H₈₀₀, applied at frequency f₁* will become out of resonance with respect to this decreased difference.

It is noted that application of H₈₀₀ (FIG. 1A) at frequency f₁* will have no effect on a population of signal photons that are initially TE polarized. This is because the resonance frequency for a population of TE polarized signal photons is f_{1**}, where f₁**=f_{TM}−f_{TE}** and f_{TE}** is the eigenfrequency of TE polarized signal photons that have been shifted by the Kerr effect due to the presence of signal photons in the TE polarized state. Thus, the transition between the polarization of signal photons from the TM state to the TE state in the presence of H₈₀₀ at frequency f₁* will stop once the population of signal photon has flipped from the TM state to the TE state.

It follows that, to invert the state of a population of signal photons in a TE state of microsphere 100, photon generator 201 be used to generate a field H₈₀₀ (FIG. 1A) with the frequency f₁**, where f_{1**}=f_{TM}−f_{TE}**. Here, f_{TE}** has the same definition provided above. That is, f_{TE}** is the eigenfrequency of TE polarized signal photons that have been shifted by the Kerr effect due to the presence of signal photons in the TE polarized state. Once the signal photons have inverted from the TE to the TM state, they are no longer responsive to field H₈₀₀ having frequency f_{1**} and therefore will not invert back to the TE state.

Some embodiments of the present invention provide an optical device 200 that acts as a signal inverter without the need for control photons. The signal inverter device applies two alternating magnetic fields H₈₀₀. One of the two alternating magnetic fields H₈₀₀ has a frequency of f_{1*} and the other alternating magnetic field H₈₀₀ has a frequency of f_{1**}, where f_{1*} and f_{1**} are defined as above. It will be appreciated that one problem with this case is that oscillation of the polarization mode of the signal photons may occur. That is, for example, a signal photon that is initially in the TE state may convert to the TM state and then convert back to the TE state. There are a number of ways to prevent this oscillation from occurring. One method is to pulse (e.g., turn on and off) alternating H₈₀₀ on a time scale that is that less than the inverse of Ωₒ. Another method is to pulse the H₈₀₀ frequencies so that they have frequencies f_{1*} and f_{1**} for a time period that is less than about the inverse of Ωₒ. At time periods outside such pulses, the frequencies of H₈₀₀ are not f_{1*} and f_{1**}.

### Flying Qubits

Some embodiments of optical device 200 can manipulate flying qubits. A qubit is a quantum bit, the counterpart in quantum computing to the binary digit or bit of classical computing. Just as a bit is the basic unit of information in a classical computer, a qubit is the basic unit of information in a quantum computer. A qubit is conventionally a system having two basis states. These basis states can be degenerate (e.g., of equal energy) states. The quantum state of the qubit is a superposition of the two basis states. The two basis states are denoted |0) and |1). The qubit can be in any superposition of these two basis states, making it fundamentally different from a bit in an ordinary digital computer.

If certain conditions are satisfied, N qubits can define an initial state that is a combination of 2^{N} classical states. This initial state undergoes an evolution, governed by the interactions that the qubits have among themselves and with external influences, providing quantum mechanical operations that have no analogy with classical computing. The evolution of the states of N qubits defines a calculation or, in effect, 2^{N} simultaneous classical calculations (e.g., conventional calculations as in those performed using a conventional computer). Reading out the states of the qubits after evolution completely determines the results of the calculations.

Several physical systems have been proposed for the qubits in a quantum computer. One system uses molecules having degenerate nuclear-spin states. See Gershenfeld and Chuang, U.S. Pat. No. 5,917,322, which is herein incorporated by reference in its entirety. More information on qubits is found in Scalable Quantum Computers, Braunstein and Lo (eds.), chapter 1, Wiley-VCH Verlag GmbH, Berlin, 2001; and Nielsen and Chuang, Quantum Computation and Quantum Information, Cambridge University Press, 2000, Cambridge, which are hereby incorporated by reference.

The term “flying qubits” is a term of art used to describe the relationship between quantum computing and quantum communication. Use of this term emphasizes that the design of qubits that are used to transmit quantum information are often different from the design of qubits used to actually perform quantum computation in a quantum computer. Advantageously, the polarization state of signal photons in microsphere 100 are used as a flying qubit in accordance with one embodiment of the present invention that is described below.

The bitstate that makes up each piece of quantum information can be referred to as a flying qubit, if the quantum information can be transmitted through a quantum network. A system that employs flying qubits requires a method to convert between stationary qubits and flying qubits, and furthermore the system must be able to transmit flying qubits between locations. Single photon wave packets (e.g., single discrete photons) used as flying qubits can have basis states encoded in either the polarization or in the spatial wave function.

As previously mentioned, the present invention uses single photon wave packets as flying qubits for applications such as quantum communication. Some embodiments of optical device 200 manipulate a single photon wave packet. This single photon wave packet serves as a flying qubit. In such embodiments, the basis states of the flying qubit correspond with the TM and TE polarization modes of microsphere 100 at a given (q, l, m) index.

A flying qubit requires a device or system for manipulating, initializing, or measuring the basis states of the flying qubit. Furthermore, in order to provide additional utility to quantum communication systems, devices that support quantum communication could provide the capability of applying quantum gates to the qubit-state of the flying qubits. Another desired feature in quantum communication systems is the ability to entangling the state of the flying qubit with the state of other qubits. The present invention advantageously provides apparatus and methods for providing these features (application of quantum gates to flying qubits as well as the entanglement of flying qubits with other qubits). Such features are provides by optical devices 200 that are designed in accordance with some embodiments of the invention in which the flying qubit is realized as a single photon wave packet (a single photon) with basis states corresponding to the TM and TE polarization modes of microsphere 100 at a given (q, l, m) index.

The physical set up of optical devices 200 in accordance with this aspect of the invention has components similar to those described above. That is, optical devices in accordance with this aspect of the invention include a microsphere 100, at least one coupling mechanism 400, and a generator 201. In some embodiments, equatorial plane 160 of microsphere 100 is circular in shape, while the remainder of microsphere 100 has a shape that deviates from circular so that the degeneracy between the resonant modes of microsphere 100 is removed. For example, in the axis perpendicular to the equatorial plane, microsphere 100 is stretched or contracted to gain a small degree of ellipticity. Each coupling mechanism 400 (e.g., coupling mechanism 400-1 and 400-2 as shown in FIG. 1A) for coupling photons into (or out of) the microsphere can be, for example, a coupling fiber or prism. In embodiments where each mechanism 400 is a fiber, the fiber can further have a region of cladding 142 near microsphere 100 that is tapered (FIG. 1A) to increase the coupling between microsphere 100 and the fiber. In embodiments where coupling mechanism 400 is an optical prism as (FIG. 2), the distance between the prism and the microsphere 100 is on the order of half the wavelength of the energy being coupled.

Mechanisms for coupling to microsphere 100 are known and have been described above. One mechanism 201 for applying an alternating magnetic field H₈₀₀, in accordance with the present invention applies an alternating electric field perpendicular to equatorial plane 160 of microsphere 100 (FIG. 1A). Alternatively, generator 201 generates H₈₀₀ by driving an alternating current through a wire that passes through a center of microsphere 100, perpendicular to equatorial plane 160. A flying qubit excited in microsphere 100 is referred to herein as signal photon(s), and excited energy used for manipulating the polarization of theses signal photons is referred to herein as the control photon(s). Therefore, a flying qubit can be considered an form of an electromagnetic energy signal.

Some embodiments of optical device 200 manipulate and/or entangle flying qubits by applying an alternating field H₈₀₀ with a frequency f_{1″2}, where f_{1″2} corresponds to the difference between the frequency of a two-photon Kerr effect shifted TE mode of a signal photon (f_{TE′2}), and the frequency of the TM mode of the signal photon f_{TM}, such that f₁″₂=f_{TM}−f_{TE}′₂ and f_{TE}′₂>f_{TE}. The frequency f_{TE}′₂ of the TE signal photon is equal to the unperturbed TE mode frequency f_{TE} of the signal photon plus the Kerr-shift due to the presence of one signal photon in the TE mode plus the Kerr-shift due to the presence of one control photon in the TE mode. In such embodiments, the presence of a control photon in the TE mode in microsphere 100 will cause a single signal photon in microsphere 100 to invert from the TE mode to the TM mode in the presence of H₈₀₀ with a frequency f₁″₂. On the other hand, the presence of a control photon in the TM mode in microsphere 100 will not have an affect on the polarization state of the signal photon regardless of its polarization state.

Some embodiments of optical device 200 manipulate and/or entangle flying qubits by applying an alternating magnetic field H₈₀₀ with a frequency f_{1′2}, where f_{1′2} corresponds to the difference between the frequency of a two-photon Kerr effect shifted TM mode of a signal photon (f_{TM}′₂), and the frequency of the TE mode of the signal photon f_{TE}, such that f₁′₂=f_{TM′2}−f_{TE} and f_{TM}′₂>f_{TM}. The frequency f_{TM}′₂ of the TM signal photon is chosen to be equal to the unperturbed TM mode frequency f_{TM} of the signal photon plus the Kerr shift due to the presence of one signal photon in the TM mode plus the Kerr-shift due to the presence of one control photon in the TM mode. In such embodiments, the presence of a control photon in the TM mode in microsphere 100 will cause a single signal photon in microsphere 100 to invert from the TM mode to the TE mode in the presence of H₈₀₀ with a frequency f₁′₂. On the other hand, the presence of a control photon in the TE mode in microsphere 100 will not have an affect on the polarization state of the signal photon regardless of its polarization state.

### Absorption Switches for the Absorption or Reflection of Photons

Another application of some embodiments of optical device 200 include a switch, where the presence of control photons in microsphere 100 can prevent the signal photons from entering microsphere 100, and in the absence of control photons, the signal photons are ultimately absorbed by microsphere 100. Optical devices 200 utilized as a switch in accordance with this aspect of the invention include microsphere 100, at least two coupling mechanisms 400 (e.g., coupling mechanisms 400-1 and 400-2, FIG. 2). Coupling mechanisms 400-1 and 400-2 can be, for example, optical prisms or optical fibers. A first of the two coupling mechanisms, coupling mechanism 400-1, for example, can be used to introduce signal photons into microsphere 100. A second of the coupling mechanisms, coupling mechanism 400-2, for example, can be used to introduce control photons into microsphere 100. The separation between coupling mechanism 400-1 and 400-2 and microsphere 100 can be chosen to match half of the wavelength of the photons. For example, the separation of coupling mechanism 400-2 used for the control photons can correlate with λ_{C}/2, where λ_{C} is the wavelength of the control photons, and similarly, the separation of the signal coupling mechanism 400-1 can be λ_{S}/2, where λ_{S} is the wavelength of the signal photons. In some embodiments of the invention, the signal coupling mechanism can be tuned to prevent the control photons from coupling. This can allow optical device 200 to absorb the signal photons if no control photons are present, and reflect the signal photons if the control photons are present, without allowing the control photons to escape through the signal coupling mechanism.

### Conclusion

All references cited herein are incorporated by reference in their entirety and for all purposes to the same extent as if each individual publication or patent or patent application is specifically and individually indicated to be incorporated by reference in its entirety for all purposes. Although the invention has been described with reference to particular embodiments, the description is only examples of the invention's applications and should not be taken as limiting. Various adaptations and combinations of features of the embodiments disclosed are within the scope of the invention as defined by the following claims.

What is claimed:

1. A method for controlling an electromagnetic energy signal, the method comprising:
exciting an electromagnetic energy signal in an optical resonant device having a dominant plane; and
applying an alternating magnetic field in the dominant plane of said optical resonant device, wherein said alternating magnetic field has a frequency that includes at least one frequency component.

2. The method of claim 1, wherein said optical resonant device comprises an optical microsphere.

3. The method of claim 2, wherein said dominant plane of said optical microsphere is the equatorial plane of said optical microsphere.

4. The method of claim 1, wherein said electromagnetic energy signal has at least one polarization state and information is stored in said polarization state.

5. The method of claim 4, wherein said polarization state is a transverse magnetic (TM) polarization mode or a transverse electric (TE) polarization mode of said electromagnetic energy signal in said optical resonant device.

6. The method of claim 1, wherein said alternating electromagnetic field has a frequency that includes a first frequency component and a second frequency component.

7. The method of claim 6, wherein a value of said first frequency component is a difference between a frequency associated with a Kerr effect shifted TE polarization mode of said electromagnetic energy signal in said optical resonant device and a frequency associated with a TM polarization mode of said electromagnetic energy signal in said optical resonant device.

8. The method of claim 6, wherein a value of said second frequency component is a difference between a frequency associated with a TE polarization mode of said electromagnetic energy signal in said optical resonant device and a frequency associated with a Kerr effect shifted TM polarization mode of said electromagnetic energy signal in said optical resonant device.

9. The method of claim 1, wherein said applying comprises generating an alternating electric field perpendicular to said dominant plane of said optical resonant device.

10. The method of claim 1, wherein said applying said alternating magnetic field in the dominant plane of said optical resonant device is pulsed.

11. The method of claim 1, wherein said electromagnetic energy signal has an intensity of about 1 photon.

12. The method of claim 11, wherein said electromagnetic energy signal is a flying qubit.

13. A method for controlling an electromagnetic energy signal, the method comprising:
exciting said electromagnetic energy signal in an optical resonant device;
exciting an electromagnetic energy control signal in said optical resonant device; and
applying an alternating magnetic field in a dominant plane of said optical resonant device, wherein said alternating magnetic field has at least one frequency component.

14. The method of claim 13, wherein said optical resonant device includes an optical microsphere.

15. The method of claim 14, wherein said dominant plane of said optical microsphere is the equatorial plane of said optical microsphere.

16. The method of claim 13, wherein said electromagnetic energy signal has at least one polarization state and information is stored in said polarization state.

17. The method of claim 16, wherein said polarization state is a transverse magnetic (TM) polarization mode or a transverse electric (TE) polarization mode of said electromagnetic energy signal in said optical resonant device.

18. The method of claim 13, wherein a value a frequency component in said at least one frequency component is a difference between a frequency associated with a Kerr effect shifted TE polarization mode of said electromagnetic energy signal in said optical resonant device and a frequency associated with a TM polarization mode of said electromagnetic energy signal in said optical resonant device.

19. The method of claim 13, wherein a value of a frequency component in said at least one frequency component is a difference between a frequency associated with a TE polarization mode of said electromagnetic energy signal in said optical resonant device and a frequency associated with a Kerr effect shifted TM polarization mode of said electromagnetic energy signal in said optical resonant device.

20. The method of claim 13, wherein a frequency component in said at least one frequency component is correlated with a difference between a Kerr effect shifted TE polarization mode of said electromagnetic energy signal in said optical resonant device and a Kerr effect shifted TM polarization mode of said electromagnetic energy signal in said optical resonant device.

21. The method of claim 13, wherein said applying comprises generating an alternating electric field perpendicular to said dominant plane of said optical resonant device.

22. The method of claim 13, wherein said duration t correlates with an amplitude of said alternating magnetic field.

23. The method of claim 13, wherein said electromagnetic energy signal has an intensity of about 1 photon.

24. The method of claim 23, wherein said electomagnetic energy signal is a qubit.

25. The method of claim 13, wherein said electromagnetic energy control signal is in a TE or TM polarization mode.

26. An electromagnetic energy signal switch comprising:
an open state, wherein an electromagnetic energy signal cannot enter an optical resonant device; wherein said open state includes exciting an electromagnetic energy control signal in said optical resonant device; and
a closed state, wherein an electromagnetic energy signal enters said optical resonant device and wherein said closed state is achieved by an absence of an electromagnetic energy control signal in said optical resonant device.
